(19) United States
(12) Patent Application Publication
(10) Pub. No.: US 2013/0007289 A1
(43) Pub. Date: Jan. 3, 2013

(54) REMOTE CONTROL SYSTEM AND REMOTE CONTROL METHOD OF THE SAME

(75) Inventors: Hyung Su Seo, Gyeonggi-do (KR); Jong Ho Kim, Seoul (KR)

(73) Assignee: RSUPPORT CO., LTD., Seoul (KR)

(21) Appl. No.: 13/523,735

(22) Filed: Jun. 14, 2012

(30) Foreign Application Priority Data
Jul. 1, 2011 (KR) 10-2011-0065476

(51) Int. Cl. G06F 15/16

(52) U.S. Cl. 709/227

(57) ABSTRACT

Provided is a remote control system and a remote control method of the same. The remote control system includes a first driver installed on a first device connected with a terminal through universal serial bus (USB) and configured to perform USB communication with the terminal, and a second driver installed on a second device connected with the first device via a network and configured to communicate with the first driver via the network. Here, the first and second drivers constitute a remote device driver for driving the terminal, and the second device transmits a command for controlling the terminal through the remote device driver and displays a display image of the terminal provided from the terminal through the remote device driver.

### CLAIM FOR PRIORITY

This application claims priority to Korean Patent Application No. 10-2011-0065476 filed on Jul. 1, 2011 in the Korean Intellectual Property Office (KIPO), the entire contents of which are hereby incorporated by reference.

### BACKGROUND OF INVENTION

1. Technical Field

Example embodiments of the present invention relate in general to a remote control system and a remote control method of the same, and more particularly, to a remote control system capable of remotely controlling a device connected through universal serial bus (USB) using a remote device driver and a remote control method employing the remote device driver.

2. Related Art

As the standard of input/output (I/O) interfaces connecting computers with peripherals, a USB interface has advantages such as ease of use, high-speed communication, high stability, generality, low implementation cost, low power consumption, and support for various operating systems (OSs).

Due to these advantages, the USB interface is being widely used as a connection means of a digital camera, an external storage device, a mobile communication terminal, etc., as well as computer I/O devices, such as a keyboard, mouse, printer and scanner.

A computer and peripherals connected through the USB interface operate as a host and devices, respectively. A plurality of devices may be connected to one host.

Lately, with the development of processors, memory technology and communication technology, a mobile communication terminal having voice and video telephony functions, and also various functions such as still photography, moving picture photography, and Internet access has been commercialized, and the USB interface with excellent communication speed, convenience, generality and extendability is used as a communication means between a personal computer (PC) and a mobile communication terminal.

For example, when a user upgrades an OS or firmware installed on a mobile communication terminal, or installs, removes or updates an application in the mobile communication terminal while using the mobile communication terminal, the user should first connect the mobile communication terminal to a computer through the USB interface, and then perform a desired operation through the computer.

At this time, the device driver of the mobile communication terminal should be installed on the computer such that the computer can recognize the mobile communication terminal as a USB device and perform normal communication after the computer and the mobile communication terminal are physically connected through the USB interface.

Since it is practically impossible to include the device drivers of all mobile communication terminals that are currently on sale in the OS of a computer, a user of a mobile communication terminal should personally obtain and install a device driver provided by the manufacturer or a seller of the corresponding device on the computer. As mobile communication terminals are becoming more functionally sophisticated, the process of installing a device driver on a computer is becoming more complicated.

However, most users physically connect mobile communication terminals to computers through USB and install device drivers. Since most users do not accurately know the process of controlling mobile communication terminals through computers, there is inconvenience in use. Also, when the aforementioned process is incorrectly performed, there is a high probability that data stored in a mobile communication terminal will be deleted, or a serious error will occur.

Furthermore, since functions of a recent mobile communication terminal, such as a cellular phone, a smart phone or a pad-type terminal, are very complicated and advanced, there is a high probability of an error or failure occurring when the mobile communication terminal is used. When an error or failure occurs in such a mobile communication terminal, it is difficult for a common user with no expertise to find the cause of the error or failure let alone correct it. Consequently, the user should request an expert or service center to diagnose and fix the trouble, which is inconvenient.

### SUMMARY OF INVENTION

Accordingly, example embodiments of the present invention are provided to substantially obviate one or more problems due to limitations and disadvantages of the related art.

Example embodiments of the present invention provide a remote control system employing a remote device driver in which a second device can remotely control a mobile terminal connected with a first device through universal serial bus (USB) using the remote device driver installed between the first and second devices connected via a network.

Example embodiments of the present invention also provide a remote control method employing a remote device driver performed in the remote control system.

In some example embodiments, a remote control system includes: a first driver installed on a first device connected with a terminal through USB, and configured to perform USB communication with the terminal; and a second driver installed on a second device connected with the first device via a network, and configured to communicate with the first driver via the network. Here, the first and second drivers constitute a remote device driver for driving the terminal, and the second device transmits a command for controlling the terminal through the remote device driver and displays a display image of the terminal provided from the terminal through the remote device driver.

Here, the first driver may check whether or not the terminal is connected, and when the terminal is connected, establish a communication channel with the terminal, request device information from the terminal, and receive device information from the terminal.

Here, the second driver may include: a virtual hub driver whose logical communication channel with the first driver is established via the network to exchange data with the first driver; and a function driver configured to perform communication limited to the terminal and manage communication of the virtual hub driver.

Here, the second device may provide a remote control module for remotely controlling the terminal to the terminal through the remote device driver, and provide a command for execution of the remote control module to the terminal through the remote device driver.

Here, the second device may provide a command for finishing execution of the remote control module, which is executed in the terminal, or a command for removal of the remote control module, to the terminal through the remote device driver.

In other example embodiments, a remote control method of a remote control system including a first device connected with a terminal through USB and a second device connected with the first device via a network includes: distributively building a remote device driver corresponding to the terminal on the first device and the second device; providing, at the second device, a command for controlling the terminal to the terminal using the remote device driver; and displaying, at the second device, a display image of the terminal provided from the terminal through the remote device driver.

Here, distributively building the remote device driver on the first device and the second device may include: requesting, at the first device, device information from the terminal; transmitting, at the first device, device information received from the terminal to the second device; and loading, at the second device, a function driver of the terminal on the basis of the device information received from the first device.

Here, providing, at the second device, the command for controlling the terminal to the terminal using the remote device driver may include: providing, at the second device, a remote control module for controlling the terminal to the terminal through the remote device driver; and providing, at the second device, a command for execution of the remote control module provided to the terminal to the terminal through the remote device driver.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a remote control system according to an example embodiment of the present invention;

FIG. 2 shows function blocks that build a remote device driver in a remote control system according to an example embodiment of the present invention;

FIG. 3 is a flowchart illustrating a method of building a remote device driver in a remote control system according to an example embodiment of the present invention;

FIG. 4 shows function blocks that perform remote control in a remote control system according to an example embodiment of the present invention; and

FIG. 5 is a flowchart illustrating a remote control method of a remote control system according to an example embodiment of the present invention.

### DETAILED DESCRIPTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in detail with reference to the accompanying drawings. To aid in understanding the present invention, like numbers refer to like elements throughout the description of the figures, and the description of the same component will not be reiterated.

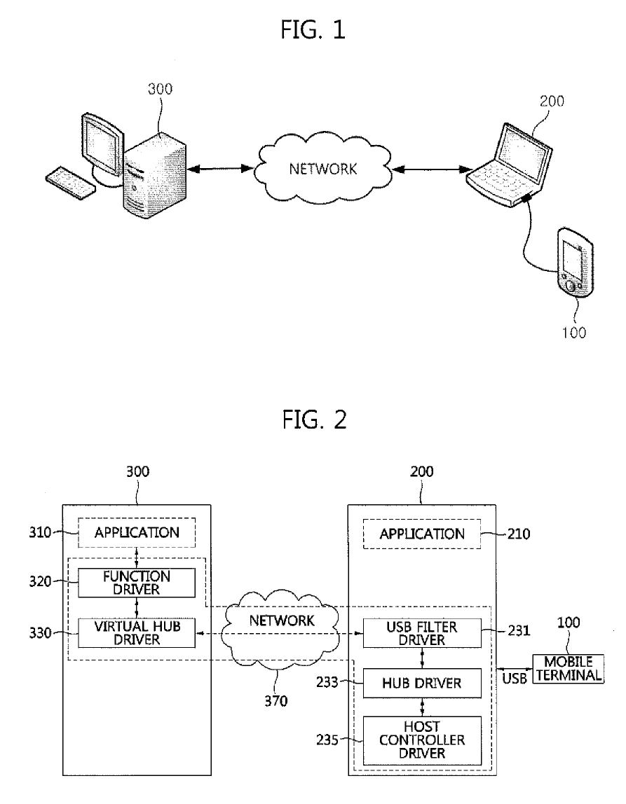

FIG. 1 is a conceptual diagram illustrating a remote control system according to an example embodiment of the present invention.

Referring to FIG. 1, a remote control system according to an example embodiment of the present invention includes a mobile terminal 100, a first device 200 connected with the mobile terminal 100 through a universal serial bus (USB) interface, and a second device 300 that is at a remote location and connected with the first device 200 via a wired or wireless network. Here, the first device 200 and the second device 300 may be any devices such as computers capable of communicating with each other via a wired or wireless network and digital information processing.

The mobile terminal 100 is a device that performs a function of a USB device, and may be, for example, a mobile communication terminal such as a smart phone, a cellular phone and a personal digital assistant (PDA), or various digital information processing terminals such as a portable multimedia player (PMP), a smart player and a pad-type terminal.

The mobile terminal 100 is physically connected with the first device 200 through a USB cable or wireless USB by a user, and may perform the corresponding operation in response to a request or command of the first device 200, or an operation corresponding to a request or command provided from the second device 300 through a remote device driver.

For example, after being physically connected with the first device 200 through the USB interface, the mobile terminal 100 provides the corresponding data in response to a standard request made by the first device 200, which functions as a physical host. Also, in response to a command and/or data provided from the second device 300 through the remote device driver, the mobile terminal 100 may perform an operation of updating an operating system (OS) or firmware, or installing, updating or removing an application, and may capture and provide an operation result screen directly to the first device 200 or to the second device 300 through the remote device driver.

The first device 200 functions as a physical host of the mobile terminal 100 connected through USB.

Specifically, the first device 200 determines whether a mobile terminal is connected to a USB port. When it is determined that the mobile terminal 100 is connected, the first device 200 establishes a temporary communication path with the second device 300 via the network, and then requests device information (e.g., a device descriptor) from the mobile terminal 100.

When a response to the device information request is received from the mobile terminal 100, the first device 200 transmits the received information (e.g., the device descriptor) to the second device 300 via the network. Here, the device information on the mobile terminal 100 may be information, for example, a vendor identification (ID) and a product ID, that enables identification of the mobile terminal 100.

The second device 300 is connected with the first device 200 via the wired or wireless network, and functions as a virtual host that substantially drives a mobile terminal physically connected with the first device 200.

Specifically, the second device 300 receives the device information on the mobile terminal 100 from the first device 200 via the network, searches for an optimum function driver for communicating with the mobile terminal 100 on the basis of the received device information on the mobile terminal 100, and loads the searched function driver into a memory.

When the remote device driver of the mobile terminal 100 is loaded through communication between the first device 200 functioning as the physical host of the mobile terminal 100 and the second device 300 functioning as the substantial host of the mobile terminal 100, an application executed on the second device 300 may recognize the mobile terminal 100 as if the mobile terminal 100 has been connected with the second computer 300, and access the mobile terminal 100.

FIG. 2 shows function blocks that build a remote device driver in a remote control system according to an example embodiment of the present invention.

Referring to FIG. 2, a first device 200 functioning as a physical host of a mobile terminal 100, which is a USB device, includes a USB filter driver 231, and a hub driver 233 and a host controller driver 235 in lower layers of the USB filter driver 231.

Meanwhile, a second device 300 that is connected with the first computer 200 via a network and functions as a substantial host of the mobile terminal 100 includes a function driver 320 in a lower layer of an application 310 and a virtual hub driver 330 that is in a lower layer of the function driver 320 and communicates with the USB filter driver 231 of the first device 200.

As shown in FIG. 2, the function driver 320, the virtual hub driver 330, the USB filter driver 231, the hub driver 233 and the host control driver 235 are hierarchically built as a remote device driver 370 according to an example embodiment of the present invention.

A function of the hierarchical device driver built on the first device 200 and the second device 300 will be described in detail below with reference to FIG. 2.

The USB filter driver 231 is in an upper layer of the hub driver 233, and manages communication of the hub driver 233. When the mobile terminal 100 is connected with the first device 200, the USB filter driver 231 recognizes connection of the mobile terminal 100 through the host controller driver 235 and the hub driver 233 in its lower layers, receives device information on the mobile terminal 100 provided from the hub driver 233, and then provides the received device information to the virtual hub driver 330 of the second device 300 logically connected via the network.

Here, the USB filter driver 231 may provide the device information to an OS of the first device 200, and the OS may compare the device information with information (e.g., registry information) stored in the system to determine whether there is a function driver of the mobile terminal 100. When there is a function driver of the mobile terminal 100, the OS may read and load the function driver into a memory.

The hub driver 233 receives a request from the second device 300 through the USB filter driver 231 in its upper layer, transfers the request to the mobile terminal 100 through the host controller driver 235 in its lower layer, receives a response from the mobile terminal 100 through the host controller driver 235, and transfers the response to the USB filter driver 231.

The host control driver 235 manages communication between the hub driver 233 and USB devices connected with a hub. In other words, the host controller driver 235 transfers data provided from the hub driver 233 to the mobile terminal 100. Also, data provided from the mobile terminal 100 toward the hub driver 233 is transferred to the host controller driver 235, and the host controller driver 235 transfers the received data to the hub driver 233 in its upper layer.

Meanwhile, the application 310 of the second device 300 may communicate with the remote device driver 370 according to an example embodiment of the present invention using a function supported by an OS.

The function driver 320 (or a USB client driver) manages communication between the application 310 in its upper layer and the virtual hub driver 320 in its lower layer.

The function driver 320 may be configured as at least one file, and may be, for example, a class driver provided by a manufacturer of the mobile terminal 100. The class driver manages communication limited to the mobile terminal 100 or a class of the mobile terminal 100. For example, the function driver 320 receives a request to a USB device from the OS and transfers the request information to the virtual hub driver 330.

The function driver 320 and the virtual hub driver 330 may communicate with each other using a separately prepared format (e.g., input/output (I/O) request packet)

The virtual hub driver 330 establishes a logical communication channel with the USB filter driver 231 via the network, receives the device information on the mobile terminal 100 provided from the hub driver 233 of the first device 200 through the communication channel, and provides the received device information to the OS of the second device 300, such that the OS of the second device 300 can load the function driver 320 of the mobile terminal 100 into a memory on the basis of the device information on the mobile terminal 100 in an enumeration process of the OS of the second device 300.

Also, the virtual hub driver 330 transmits the request provided from the function driver 320 in its upper layer to the USB filter driver 231 through the communication channel.

Here, the USB filter driver 231 and the virtual hub driver 330 may establish the logical communication channel due to a specific application 210 and the specific application 310 which are previously installed on the first device 200 and the second device 300, respectively. The specific application 210 installed on the first device 200 may be configured to transmit data provided from the USB filter driver 231 to the second device 300 via the network, and provide data received from the virtual hub driver 330 of the second device 300 to the USB filter driver 231.

Also, the specific application 310 installed on the second device 300 may be configured to transmit data provided from the virtual hub driver 330 to the first device 200 via the network, and provide data received from the USB filter driver 231 of the first device 200 to the virtual hub driver 330.

In particular, when the USB filter driver 231 receives the device information from the mobile terminal 100, the specific application 210 installed on the first device 200 transmits the device information to the second device 300, and the specific application 310 installed on the second device 300 receives and provides the device information to the OS through the virtual hub driver 330, such that the OS can search for a function driver corresponding to the device information.

As shown in FIG. 2, in the remote control system according to an example embodiment of the present invention, the USB filter driver 231, the hub driver 233 and the host controller driver 235 are in the first device 200 physically connected with the mobile terminal 100, and the virtual hub driver 330 and the function driver 320 are hierarchically built on the second computer 300 present at a remote location via a network. Thus, it is possible to access the mobile terminal 100 via the second device 300 at the remote location without installing a function driver corresponding to the mobile terminal 100 directly on the first device 200 physically connected with the mobile terminal 100.

Also, in the remote control system according to an example embodiment of the present invention, the second device 300 can access and control the mobile terminal 100 substantially connected with the first device 200 as if the mobile terminal 100 was directly connected with the second device 300, such that the second device 300 can remotely control the mobile terminal 100 connected to the first device 200 through USB.

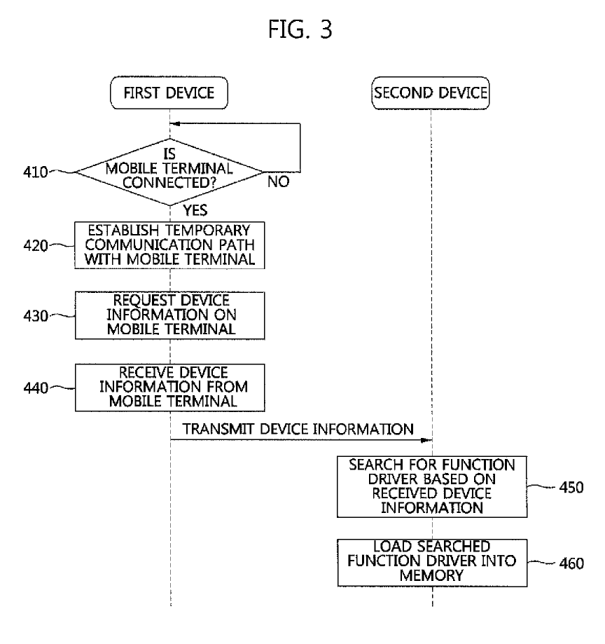

FIG. 3 is a flowchart illustrating a method of building a remote device driver in a remote control system according to an example embodiment of the present invention.

Referring to FIG. 3, a first device determines whether a mobile terminal is connected to a USB hub (step 410). When it is determined that a mobile terminal is connected, the first device establishes a temporary communication path between an end point of the mobile terminal and a second device functioning as a physical host via a network (step 420).

Subsequently, the first device requests device information from the mobile terminal through the established temporary communication path (step 430), and receives device information from the mobile terminal in response to the request (step 440). Here, the device information may include a vendor ID, a product ID, etc. of the mobile terminal.

Subsequently, the first device transmits the received device information on the mobile terminal to the second device connected via the network. At this time, a specific application previously installed on the first device may drive a communication interface to transmit the device information to the second device.

Although not shown in FIG. 3, the first device may be configured to search for the corresponding function driver on the basis of the device information received from the mobile terminal before transmitting the device information to the second device, load the corresponding function driver into a memory when the corresponding function driver is searched for, and transmit the device driver to the second device only when the corresponding function driver is not searched for.

The second device receives the device information on the mobile terminal from the first device, and searches for a function driver corresponding to the received device information (step 450). At this time, a specific application previously installed on the second device may receive and provide the device information transmitted from the first device to an OS through a virtual hub driver, and the OS may compare the provided device information with a system registry and search for a function driver.

Subsequently, the second device reads and loads the searched function driver into a memory (step 460). At this time, when the corresponding function driver is not in the second device, the second device may obtain the corresponding function driver from a manufacturer server of the mobile terminal or a separate function driver database via a network.

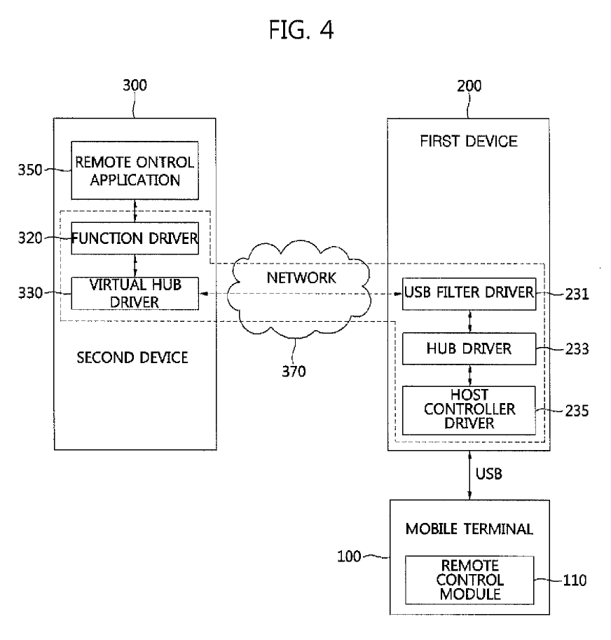

FIG. 4 is a block diagram showing a constitution of a remote control system employing a remote device driver according to an example embodiment of the present invention.

Referring to FIG. 4, a remote control system includes a mobile terminal 100 which is a remote control target, a first device 200 connected with the mobile terminal 100 through USB, and a second device 300 which is a control-side device connected with the first device 200 via a network to perform remote control.

As described with reference to FIGS. 1 to 3, a remote device driver 370 is built on the second device 300 and the first device 200, and operates as if the mobile terminal 100 has been connected to the second device 300 through USB. Specifically, a function driver 320 corresponding to the mobile terminal 100 is installed in the second device 300, and a virtual hub driver 330 is installed in a lower layer of the function driver 320. Also, a USB filter driver 231, which is logically connected with the virtual hub driver 330 via the network to perform communication, and a hub driver 233, are installed in the first device 200, and a host controller driver 235 is installed in a lower layer of the hub driver 233.

The second device 300 includes a remote control application 350 that performs remote control, and the remote control application 350 provides a remote control module 110 to the mobile terminal 100 through the remote device driver 370.

At this time, using a command interface corresponding to an OS of the mobile terminal, the remote control application 350 may provide the remote control module 110 to the mobile terminal 100 through the remote device driver 370. For example, when the OS of the mobile terminal 100 is Android, the command interface may be an Android debug bridge (ADB) server.

The remote control application 350 of the second device 300 provides a command for executing the remote control module 110 stored in the mobile terminal 100 to the mobile terminal 100 through the remote device driver 370, and the mobile terminal executes the remote control module 110 in response to the command.

Subsequently, the remote control module 110 executed in the mobile terminal 100 captures a display image of the mobile terminal 100 and transfers the captured image to the remote control application 350 of the second device 300 through the remote device driver 370, and the remote control application 350 displays the captured image of the mobile terminal 100 received through the remote device driver 370. Here, the remote control module 110 of the mobile terminal 100 may capture and provide a display image to the second device 300 at predetermined time intervals or only when there is a change in a screen. Also, the remote control module 110 of the mobile terminal 100 may compare a captured image with a previously captured image and only provide a difference between the two images to the second device 300.

After displaying the display image provided from the mobile terminal 100, the second device 300 transmits a command generated by a user to the mobile terminal 100 through the remote device driver 370. Then, the mobile terminal executes the command, and captures and provides a display image showing the execution result to the second device 300 through the remote device driver 370. This process is repeated while remote control is performed.

When the remote control is finished, the second device 300 may provide a command for finishing execution and/or for removal of the remote control module 110 executed in the mobile terminal 100 to the mobile terminal 100 through the remote device driver 370. In response to the command, the mobile terminal 100 may finish execution of the remote control module 110 and/or remove the remote control module 110.

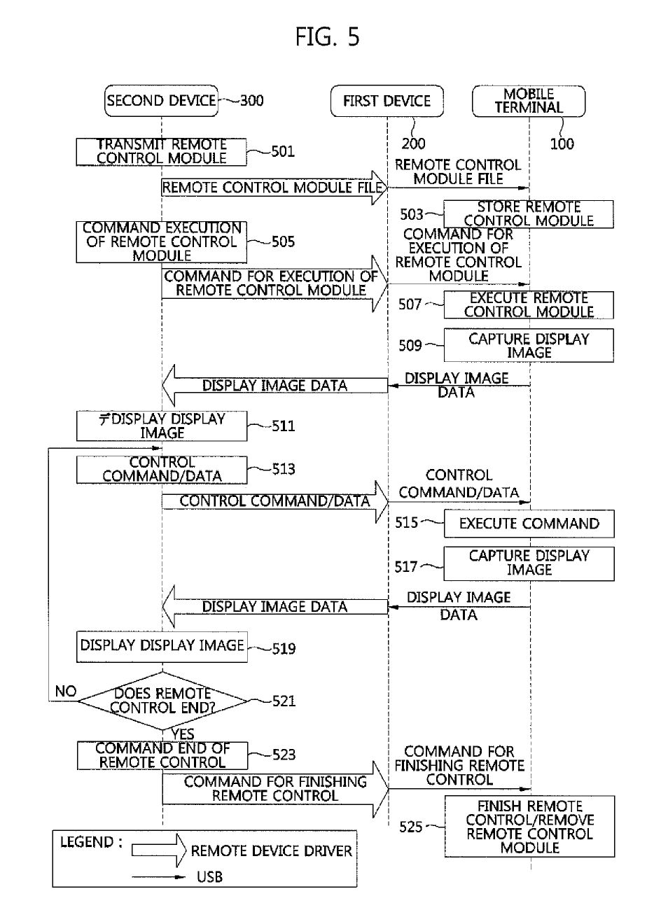

FIG. 5 is a flowchart illustrating a remote control method employing a remote device driver according to an example embodiment of the present invention, that is, a remote control process of a mobile terminal 100 performed after a remote device driver is built between a second device 300 and a first device 200 through the remote device driver building process illustrated in FIG. 3.

Referring to FIG. 5, the second device 300 transmits a remote control module 110 for remotely controlling the mobile terminal 100 connected to the first device 200 through USB to the mobile terminal 100 through the remote device driver built between the second device 300 and the first device 200 (step 501). At this time, a file of the remote control module 110 is transmitted to the first device 200 through the remote device driver and then provided to the mobile terminal 100 through a USB interface.

The mobile terminal 100 stores the remote control module 110 provided from the second device 300 (step 503).

Subsequently, the second device 300 transmits a command for execution of the remote control module 110 stored in the mobile terminal 100 according to instructions of a user to the mobile terminal 100 through the remote device driver (step 505), and the mobile terminal 100 executes the stored remote control module 110 in response to the command received from the second device 300 (step 507).

When the remote control module 110 is executed in the mobile terminal 100 as described above, the remote control module 110 captures a screen currently displayed on the mobile terminal 100 and transmits the captured display image to the second device 300 through the remote device driver (step 509).

The second device 300 displays the display image provided from the mobile terminal 100 (step 511). When the display image of the mobile terminal 100 is displayed on the second device 300, the user of the second device 300 may control the mobile terminal 100 while looking at the display image of the mobile terminal 100.

When control instructions for control of the mobile terminal 100 are provided from the user, the second device 300 provides a control command or data corresponding to the control instructions to the mobile terminal 100 through the remote device driver (step 513).

The mobile terminal 100 executes the instructions corresponding to the control command or data provided from the second device 300 (step 515), and captures and transmits an execution result screen to the second device 300 (step 517). Then, the second device 300 displays the display image provided from the mobile terminal 100 (step 519).

Also, the second device 300 determines whether instructions for finishing remote control are provided from the user (step 521). When instructions for finishing remote control are provided from the user, the second device 300 provides a command for finishing remote control to the mobile terminal 100 through the remote device driver (step 523). Here, the command for finishing remote control may include a command for removal of the remote control module 110 installed in the mobile terminal 100.

When the command for finishing remote control is provided from the second device 300, the mobile terminal 100 finishes the remote control module 110 that is being executed (step 525). At this time, if the command for removal of the remote control module 110 is included in the command for finishing remote control, the mobile terminal 100 may remove the installed remote control module 110 after finishing execution of the remote control module 110.

On the other hand, when it is determined in step 521 that instructions for control of the mobile terminal are provided from the user, the process proceeds back to step 513 and the second device 300 performs the subsequent steps.

In the above-described remote control system and method using a remote device driver, a remote device driver is hierarchically built between a first device and a second device connected via a network, and the second device transmits a command and/or data for controlling a mobile terminal connected to the first device through USB to the first device and displays a display image that is an execution result screen of the mobile terminal received from the mobile terminal through the remote device driver.

Consequently, it is possible to install a remote device driver for driving a mobile terminal connected through USB without intervention of a user, and improve convenience in use of the mobile terminal by remotely controlling the mobile terminal through the installed remote device driver.

While the example embodiments of the present invention and their advantages have been described in detail, it should be understood that various changes, substitutions and alterations may be made herein without departing from the scope of the invention.

What is claimed is:

1. A remote control system, comprising:
a first driver installed on a first device connected with a terminal through universal serial bus (USB), and configured to perform USB communication with the terminal; and
a second driver installed on a second device connected with the first device via a network, and configured to communicate with the first driver via the network,
wherein the first and second drivers constitute a remote device driver for driving the terminal, and
the second device transmits a command for controlling the terminal through the remote device driver and displays a display image of the terminal provided from the terminal through the remote device driver.

2. The remote control system of claim 1, wherein the first driver checks whether or not the terminal is connected, and when the terminal is connected, establishes a communication channel with the terminal, requests device information from the terminal, and receives device information from the terminal.

3. The remote control system of claim 2, wherein the second driver includes:
a virtual hub driver whose logical communication channel with the first driver is established via the network to exchange data with the first driver; and
a function driver configured to perform communication limited to the terminal and manage communication of the virtual hub driver.

4. The remote control system of claim 1, wherein the second device provides a remote control module for remotely controlling the terminal to the terminal through the remote device driver, and provides a command for execution of the remote control module to the terminal through the remote device driver.

5. The remote control system of claim 4, wherein the second device provides a command for finishing execution of the remote control module executed in the terminal, or a command for removal of the remote control module, to the terminal through the remote device driver.

6. A remote control method of a remote control system including a first device connected with a terminal through universal serial bus (USB) and a second device connected with the first device via a network, comprising:
distributively building a remote device driver corresponding to the terminal on the first device and the second device;
providing, at the second device, a command for controlling the terminal to the terminal using the remote device driver; and
displaying, at the second device, a display image of the terminal provided from the terminal through the remote device driver.

7. The remote control method of claim 6, wherein distributively building the remote device driver on the first device and the second device includes:
requesting, at the first device, device information from the terminal;
transmitting, at the first device, device information received from the terminal to the second device; and
loading, at the second device, a function driver of the terminal on the basis of the device information received from the first device.

8. The remote control method of claim 6, wherein providing, at the second device, the command for controlling the terminal to the terminal using the remote device driver includes:
providing, at the second device, a remote control module for controlling the terminal to the terminal through the remote device driver; and
providing, at the second device, a command for execution of the remote control module provided to the terminal to the terminal through the remote device driver.
